(19) United States
(12) Patent Application Publication
(10) Pub. No.: US 2016/0019518 A1
(43) Pub. Date: Jan. 21, 2016

(54) HANDHELD COMPUTING DEVICE AND ELECTRONIC RECEIPT SERVER

(71) Applicant: TOSHIBA TEC KABUSHIKI KAISHA, Tokyo (JP)

(72) Inventor: Koichi SUGIYAMA, Izunokuni Shizuoka (JP)

(21) Appl. No.: 14/601,668

(22) Filed: Jan. 21, 2015

(30) Foreign Application Priority Data
Jul. 17, 2014 (JP) 2014-147044

(51) Int. Cl. G06Q 20/20; G06Q 40/00; G06F 3/0484

(52) U.S. Cl. CPC G06Q 20/209; G06F 3/0484; G06Q 40/12

(57) ABSTRACT

A handheld computing device includes a control unit including a processor and memory, a communication interface controlled by the control unit to communicate with an electronic receipt server that stores electronic receipt data, and a display unit controlled by the control unit to display a user interface. The user interface includes a transaction identifying symbol, a listing of one or more items indicated as having been purchased based on data of a previously issued electronic receipt stored in the electronic receipt server and transmitted to the handheld computing device in response to an update request to the data, and a deletion mark overlaid on or in proximity to one of the items to indicate that the item has been returned.

### CROSS-REFERENCE TO RELATED APPLICATION

This application is based upon and claims the benefit of priority from Japanese Patent Application No. 2014-147044, filed Jul. 17, 2014, the entire contents of which are incorporated herein by reference.

### FIELD

Embodiments described herein relate generally to a handheld computing device and an electronic receipt server.

### BACKGROUND

In the related art, an electronic receipt system generates and manages an electronic receipt that includes computerized information about a purchase transaction corresponding to information printed on a paper receipt. In such an electronic receipt system, an electronic receipt server stores the electronic receipt and transmits a copy thereof to a computing device of the purchaser.

### DESCRIPTION OF THE DRAWINGS

FIG. 1 illustrates an entire electronic receipt system according to an embodiment.

FIG. 2 is a block diagram of a POS terminal in the electronic receipt system.

FIG. 3 is a block diagram of an electronic receipt server in the electronic receipt system.

FIG. 4 is a block diagram of an electronic receipt management server in the electronic receipt system.

FIG. 5 is a memory map of data stored in an electronic receipt storage unit of the electronic receipt management server.

FIG. 6 illustrates a detail of a returned merchandise data unit of the electronic receipt management server.

FIG. 7 illustrates a mobile terminal in the electronic receipt system.

FIG. 8 illustrates a flow of a control processing carried out by the POS terminal.

FIG. 9 illustrates a flow of a control processing carried out by the electronic receipt server.

FIG. 10 illustrates a functional block of the electronic receipt server.

FIG. 11 illustrates a flow of a control processing carried out by the electronic receipt management server.

FIG. 12 illustrates a flow of a control processing carried out by the mobile terminal.

FIG. 13 shows the mobile terminal on which an electronic receipt is displayed.

FIG. 14 shows the mobile terminal on which the electronic receipt reflecting the return of merchandise.

### DETAILED DESCRIPTION

Exemplary embodiments are to provide an electronic receipt processing apparatus and a program thereof which modify the electronic receipt.

In general, according to one embodiment, a handheld computing device includes a control unit including a processor and memory, a communication interface controlled by the control unit to communicate with an electronic receipt server that stores electronic receipt data, and a display unit controlled by the control unit to display a user interface. The user interface includes a transaction identifying symbol, a listing of one or more items indicated as having been purchased based on data of a previously issued electronic receipt stored in the electronic receipt server and transmitted to the handheld computing device in response to an update request to the data, and a deletion mark overlaid on or in proximity to one of the items to indicate that the item has been returned.

Hereinafter, an embodiment will be described based on the drawings. In the embodiment, an electronic receipt management server is described as an electronic receipt processing apparatus. The exemplary embodiment is not limited to the description of the embodiment.

In addition, a “receipt” in the disclosure represents a paper receipt which is printed by a printing unit. An “electronic receipt” in the disclosure represents a receipt which computerized transactional information (including merchandise name, price, calculated amount of money, or the like). The electronic receipt may be stored in an electronic receipt management server or in an electronic receipt server.

In addition, “receipt data” in the disclosure represents data which is used to perform printing by the printing unit, and represents data which is a base of the electronic receipt. The receipt data will be described in detail.

In addition, the electronic receipt is used for confirming the detail of shopping by customers for themselves. In other words, the electronic receipt is transmitted to a mobile terminal of the customer from the electronic receipt processing apparatus, or the electronic receipt of the electronic receipt processing apparatus is referred to by the customer via a network from the mobile terminal. Here, the generating of the electronic receipt, the transmitting of the electronic receipt to the mobile terminal, or the referring by the customer is included in issuing of the electronic receipt.

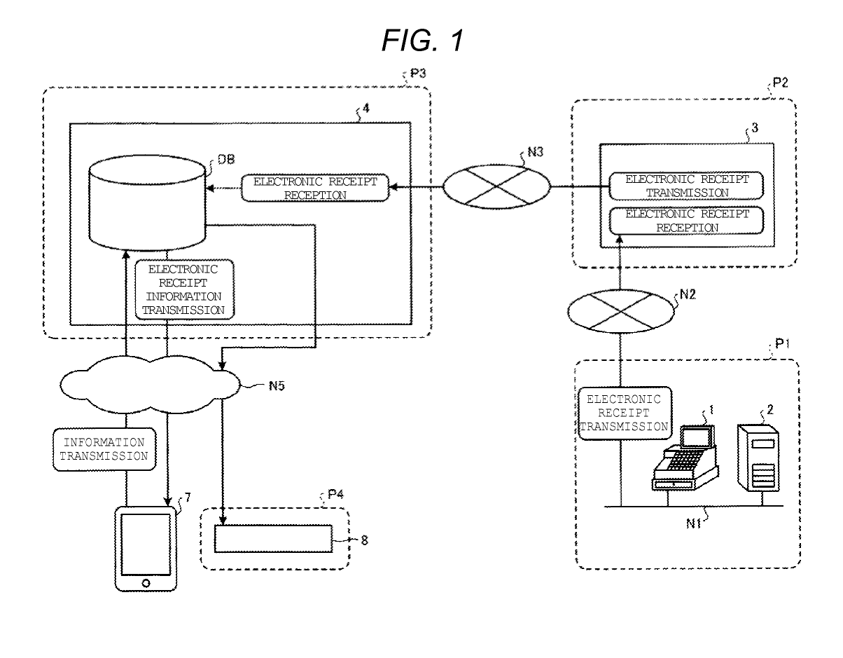

FIG. 1 illustrates an entire electronic receipt system according to the embodiment. As illustrated in FIG. 1, the electronic receipt system includes a point of sales (POS) terminal 1, a store server 2, an electronic receipt server 3, an electronic receipt management server 4 (electronic receipt processing apparatus), and a mobile terminal 7.

The POS terminal 1 and the store server 2 are provided inside a store P1. The POS terminal 1 and the store server 2 are connected so as to communicate via an in-store network N1, such as a local area network (LAN). In addition, the POS terminal 1 and the store server 2 may be connected to a network N2 which links the store P1 with a head office P2 via a network device (not illustrated), such as a router connected to the in-store network N1. Here, for example, the network N2 is a dedicated line, such as the Internet or a virtual private network (VPN).

The POS terminal 1 is a merchandise sales data processing apparatus which performs a merchandise sales data processing, such as a settlement processing. For every transaction, the POS terminal 1 generates the receipt data including a transaction content of the merchandise, which is a settlement target, and issues the receipt by a printing unit 20 printing the receipt data, which will be described later. In addition, the POS terminal 1 outputs (hereinafter, “transmit”) the electronic receipt of which a data format is converted, to the electronic receipt server 3 via the network N2. Transmitting the electronic receipt to the electronic receipt server 3 is described as issuing the electronic receipt. A transmission method of the electronic receipt is not limited particularly, and a universal protocol, such as a HTTP or a HTTPS, may be employed.

The store server 2 generally performs management of data processing, such as the merchandise sales data processing, which is performed at the POS terminal 1. For example, the store server 2 stores and manages the merchandise sales data which is generated by the POS terminal 1 carrying out the merchandise sales data processing, and stores and manages a merchandise data file or the like which is used in the merchandise sales data processing.

In addition, the number of the POS terminal 1 located in the store P1 is not particularly, and may be plural. In addition, in the embodiment, the POS terminal 1 transmits the electronic receipt. However, the electronic receipt server 3 may transmit the electronic receipt, after the store server 2 or a conversion apparatus (not illustrated) generates the electronic receipt by converting the data format of the receipt data generated at the POS terminal 1 and transmits the electronic receipt to the electronic receipt server 3.

The electronic receipt server 3 is provided in the head office P2 of an entity which operates a store or a store chain (hereinafter, store), and functions as a receipt management server for the entity, which manages the electronic receipt thereof. The electronic receipt server 3 has, for example, functions of turnover management, turnover analysis, or inventory management of the entity.

In addition, the electronic receipt server 3 receives the electronic receipt transmitted from the POS terminal 1 via the network N2. In addition, the electronic receipt server 3 transmits the received electronic receipt to the electronic receipt management server 4 via the network N3 which links the head office P2 with an electronic receipt center P3.

Here, the network N3 is a dedicated line, such as the Internet or the VPN. In addition, the transmission method of the electronic receipt is not limited particularly, and the universal protocol, such as the HTTP or the HTTPS, may be employed.

The electronic receipt management server 4 is located in the electronic receipt center P3. The electronic receipt center P3 is, for example, a third party other than the entity that manages the electronic receipt with the electronic receipt server 3. In addition, the electronic receipt server 3 may also be managed by the third party.

The electronic receipt management server 4 collectively manages the electronic receipt of various entities which operate stores. The electronic receipt management server 4 performs membership registration processing through a process, which will be described later, and stores and manages membership data, such as a name, a membership code of a customer (member) who obtained it, or transmission destination information (for example, an email address) of the mobile terminal 7, each of which is reception destination specification information, with respect to every membership code in a membership master maintained in a database DB. In addition to the electronic receipt management server 4, a membership management server may perform storage and management of the membership data. The reception destination specification information is described by using the membership code as an example, but the reception destination specification information may be any information which can specify the reception destination of the electronic receipt, such as a telephone number of a mobile phone and an email address.

In addition, the electronic receipt management server receives the electronic receipt transmitted from the electronic receipt server 3 via the network N3, and stores and manages the electronic receipt, with respect to each membership code in an electronic receipt storage unit 442 (storage unit), to be described later, that is maintained in the database DB. More specifically, the electronic receipt includes information such as the membership code, other than the transaction content (merchandise sales data) of the merchandise, and is managed in correlation with the membership code of a corresponding member.

In addition, when the electronic receipt is stored in the database DB, the electronic receipt management server 4 specifies the reception destination (mobile terminal 7) by referring to the reception destination information that is correlated with the membership code of the electronic receipt. The electronic receipt management server 4 transmits the electronic receipt stored in the database DB to the reception destination via a network N5, which will be described later.

In addition, when an electronic receipt inquiry designating a membership code is received from the mobile terminal 7 connected via the network N5 (to be described later), the electronic receipt management server 4 extracts the electronic receipt corresponding to the membership code from the database DB, and transmits the electronic receipt data to the mobile terminal 7.

The mobile terminal 7 is a terminal apparatus, such as a smart phone, a mobile phone, a personal digital assistant (PDA), and a tablet computer, which is used by a user (customer) of the system. An application, such as a web browser, for displaying various types of information provided on the network N5, is installed in the mobile terminal 7. In addition, instead of the mobile terminal 7, a terminal apparatus, such as a PC, may be employed.

The mobile terminal 7 performs the membership registration to the system by accessing the electronic receipt management server 4 via the network N5. Here, the network N5 is the Internet or the various public networks.

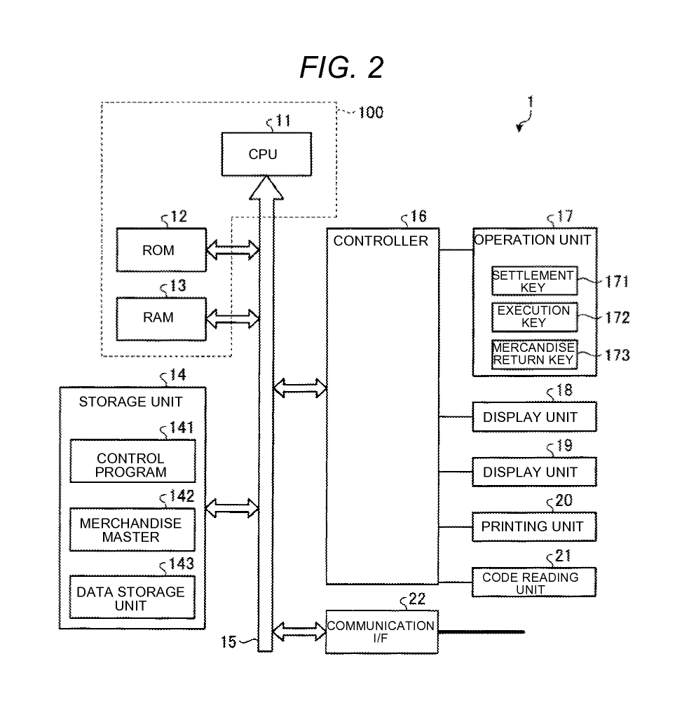

The mobile terminal 7 displays the membership code of the member in a display unit 73 (refer to FIG. 7) as a code symbol, such as a bar code or a two-dimensional code. The customer shows the mobile terminal 7 on which the code symbol is displayed to a salesperson when the transaction is carried out in the store P1. Alternatively, the customer may show a membership card, which is issued according to the membership registration, and on which the membership code is printed in a form of the code symbol, such as the bar code or the two-dimensional code. The salesperson reads out the code symbol printed on the membership card or the code symbol displayed on the mobile terminal 7 with a code reading unit 21 (refer to FIG. 2) having, for example, a scanner connected to the POS terminal 1. Accordingly, it is possible to correlate the membership code of the customer with the receipt data generated according to the merchandise sales data processing at the POS terminal 1.

The mobile terminal 7 receives the electronic receipt of the transaction transmitted from the electronic receipt management server 4 after the settlement (transaction) processing at the POS terminal 1, via the network N5. In addition, after transmitting electronic receipt inquiry information designating the membership code and a transaction date to the electronic receipt management server 4 via the network N5, the mobile terminal 7 receives the electronic receipt of the member from the electronic receipt management server 4. In addition, the mobile terminal 7 displays the received electronic receipt in the display unit 73, which will be described later.

In the electronic receipt system of the embodiment, the electronic receipt which indicates the detail (including the merchandise name, the price, amount of money transacted, or the like) of the transaction (settlement) generated by the POS terminal 1 of the store P1 performing the merchandise sales data processing is transmitted to the electronic receipt management server 4 via the electronic receipt server 3, and becomes available on the web. Therefore, as the mobile terminal 7 which has the web browser installed thereon designates a uniform resource locator (URL), it is possible to display the electronic receipt available on the web through the web browser after downloading the electronic receipt to the mobile terminal 7. In addition, the electronic receipt may be obtained using an application for downloading the electronic receipt to the mobile terminal 7.

A manufacturer server 8 is located at a manufacturer P4. The manufacturer P4 manufactures merchandise for sales at the store P1. The manufacturer server 8 receives the electronic receipt from the electronic receipt management server 4 via the network N5.

Next, a configuration of main components included in the electronic receipt system according to the embodiment will be described.

First, a configuration of the POS terminal 1, which functions as the merchandise sales data processing apparatus, will be described with reference to a block diagram in FIG. 2. In FIG. 2, the POS terminal 1 includes a central processing unit (CPU) 11, which performs various arithmetic operations and generally controls each unit of the POS terminal 1, a read only memory (ROM) 12, which stores various programs or data, a random access memory (RAM) 13, which temporarily stores various programs or stores various kinds of rewritable data, and a storage unit 14, which stores various programs, and the like. The CPU 11, the ROM 12, the RAM 13, and the storage unit 14 are connected to each other via a data bus 15. The CPU 11, the ROM 12, and the RAM 13 configure a control unit 100. In other words, as the CPU 11 operates according to a control program 141 stored in the ROM 12 or the storage unit 14 and developed in the RAM 13, the control unit 100 performs the control processing, which will be described later.

In addition, an operation unit 17, a display unit for the salesperson 18, a display unit for the customer 19, the printing unit 20, and the code reading unit 21 are connected to the data bus 15 via a controller 16. The operation unit 17 has a settlement key 171, an execution key 172, a returning merchandise key 173, and a numeric keypad which has numbers thereon or various function keys.

The settlement key 171 is a key for an operation when the transaction with a customer is completed. The execution key 172 is a key for performing a returning merchandise processing. The returning merchandise key 173 is a key for an operation to initiate the returning merchandise processing at the POS terminal 1, when the customer returns the entire purchased items or a part of purchased items after completing the transaction.

The storage unit 14 is an auxiliary storage apparatus, such as a hard disk drive (HDD) or a solid state drive (SSD). The storage unit 14 has a merchandise master 142 and a data storage unit 143, in addition to the control program 141. The merchandise master 142 stores the merchandise information (merchandise name information, price information, merchandise attribute information or the like) corresponding to a code specifying the item (e.g., Japan Article Number JAN)). The merchandise master 142 is a copy of the merchandise master, which is stored in the store server 2.

The data storage unit 143 stores a POS number for distinguishing the POS terminal 1 with the other POS terminals, an entity code (identification code of the entity which operates the store), a business type and business category code, and a store code corresponding to the store P1 in which the POS terminal 1 is located. The data storage unit 143 further stores the membership code, the merchandise code, and the transaction number. Here, the business type and business category code is a code (classification code) used to categorize a business type and a business category of the store, such as a convenience store, a supermarket, a department store, a pharmacy, a restaurant, and an eating house, for example. In addition, the business type and the business category may be arbitrarily set according to the preference of the user. In addition, the entity code (identification code of the entity which operates the store) and the business type and business category code may be stored in the electronic receipt server 3.

The display unit for the salesperson 18 is placed toward the salesperson, is a liquid crystal display or the like, and displays various kinds of information, such as the merchandise name of the merchandise that is registered for sales, the price, a total price of one transaction, and an amount of change. The display unit for the customer 19 is placed toward the customer, is a liquid crystal display or the like, and displays various kinds of information related to the transaction, such as the merchandise name of the merchandise that is registered for sales, the price, the total price of one transaction, and the amount of change.

The printing unit 20 is an apparatus which performs printing of the receipt or a journal.

The code reading unit 21 is a scanner apparatus which optically reads out the code symbol, such as the bar code or the two-dimensional code. The code reading unit 21 reads out the code symbol attached to the merchandise, the code symbol printed on the membership card, or the code symbol displayed on the mobile terminal 7. The control unit 100 inputs the information corresponding to the read code symbol. In addition, the code symbol attached to the merchandise has information about the merchandise code or the like for specifying the merchandise. In addition, the code symbol displayed in the mobile terminal 7 has information about the membership code (customer code) for specifying the reception destination. In addition, the membership code may be stored magnetically or electrically in the membership card or the mobile terminal 7. In this case, the stored membership code is read out by a reading apparatus. The control unit 100 inputs the read membership code.

The control unit 100 may be connected to the network N2 via a communication I/F 22 connected to the data bus 15. In addition, the control unit 100 is connected to the storage unit 14 via the data bus 15.

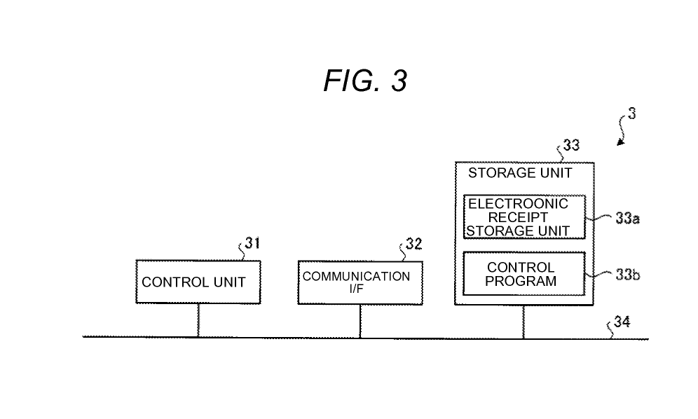

Next, a configuration of the electronic receipt server 3 which functions as a receipt management server for the entity will be described using a block diagram of FIG. 3. The electronic receipt server 3 has the control unit 31 which performs various arithmetic operations and generally controls each unit of the electronic receipt server 3. The control unit 31 is the computer which has a CPU, a ROM which stores various programs or data, a RAM which temporarily stores various programs or stores various kinds of rewritable data, a RTC unit which measures current date and time and the like.

The control unit 31 may be connected to the network N2 or the network N3 via a communication I/F 32, which is connected to a bus 34. In addition, the control unit 31 is connected to the storage unit 33 via the bus 34 and the like.

The storage unit 33 stores the electronic receipt for an entity that operates the store in the electronic receipt storage unit 33a. The electronic receipt stored in the electronic receipt storage unit 33a includes the membership code, the entity code (identification code of the entity which operates the store), the store code, the POS number of the POS terminal 1, the transaction number, the merchandise information, or the merchandise sales data (including the merchandise name, the price, the amount of money transacted, or the like).

In addition, the storage unit 33 stores a control program 33b for storing the electronic receipt in the electronic receipt storage unit 33a and for transmitting the electronic receipt data to the electronic receipt management server 4.

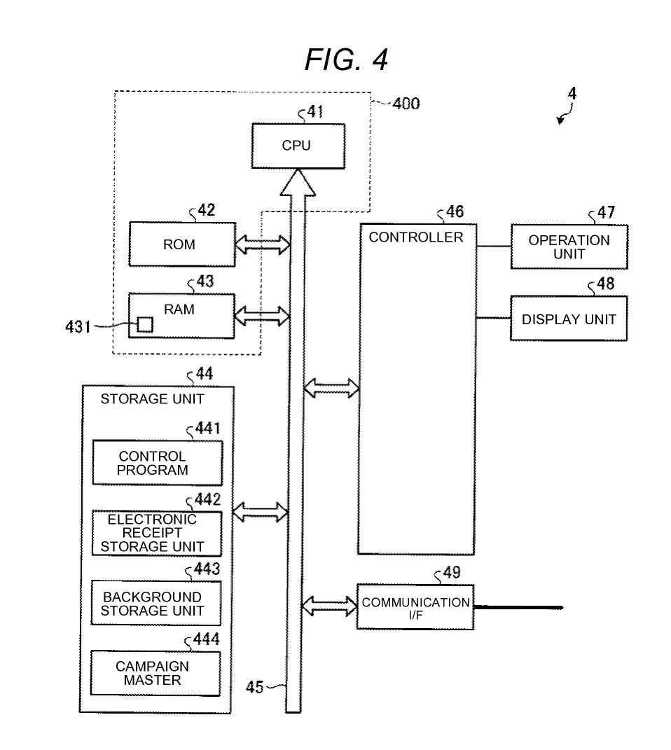

Next, a configuration of the electronic receipt management server 4, which functions as a receipt management server for customer, will be described using a block diagram in FIG. 4. In FIG. 4, the electronic receipt management server 4 is provided with a CPU 41, which is a main control body, a ROM 42, which stores various programs, a RAM 43, which develops various data, and a storage unit 44, which stores various programs and the like. The CPU 41, the ROM 42, the RAM 43, and the storage unit 44 are connected to each other via a data bus 45. The CPU 41, the ROM 42, and the RAM 43 configure a control unit 400 (modification unit). In other words, as the CPU 41 is operated according to a control program 441 which is stored in the ROM 42 or in the storage unit 44 and is developed in the RAM 43, the control unit 400 performs the control processing, which will be described later. The RAM 43 includes a merchandise return data unit 431 which stores merchandise return data.

In addition, an operation unit 47 and a display unit 48 are connected to the data bus 45 via a controller 46. The operation unit 47 has the numeric keypad which has numbers thereon or various function keys. The display unit 48 displays various kinds of information related to an electronic receipt control, which is performed by the electronic receipt management server 4.

The control unit 400 may be connected to the network N3 and the network N5 via a communication I/F 49 (first obtaining unit, second obtaining unit, output unit), which is connected to the data bus 45. In addition, the control unit 400 is connected to the storage unit 44 via the data bus 45.

The storage unit 44 has the electronic receipt storage unit 442 for collectively storing the electronic receipt of various entities which operate stores, in addition to a membership master management unit (not illustrated) for storing and managing the membership master. More specifically, the electronic receipt storage unit 442 manages the electronic receipt for various entities which operate the stores with respect to each membership code. Therefore, the data in the electronic receipt storage unit 442 is sorted by entity code which identifies the entity that operates the store. In addition, the data area for each company code may be further sorted by store code.

In addition, the storage unit 44 has a background storage unit 443, which stores background information of the electronic receipt to be displayed in the mobile terminal 7. In the background storage unit 443, the background information of a background image displayed on the mobile terminal 7, such as a pattern, a picture, or a watermark character, is stored. By adding the background information to the electronic receipt, it is possible to change the background of the electronic receipt which is displayed on the mobile terminal 7.

The electronic receipt in the electronic receipt storage unit 442 is stored with respect to each company code. The electronic receipt includes the membership code, the POS number of the POS terminal 1, a transaction number, or the merchandise sales data (including the merchandise name, the price, and the amount of money transacted). In addition, the store code may be included. The amount of money transacted is, for example, a subtotal. However, the amount of money transacted may be an amount of payment or a total amount of money including the tax.

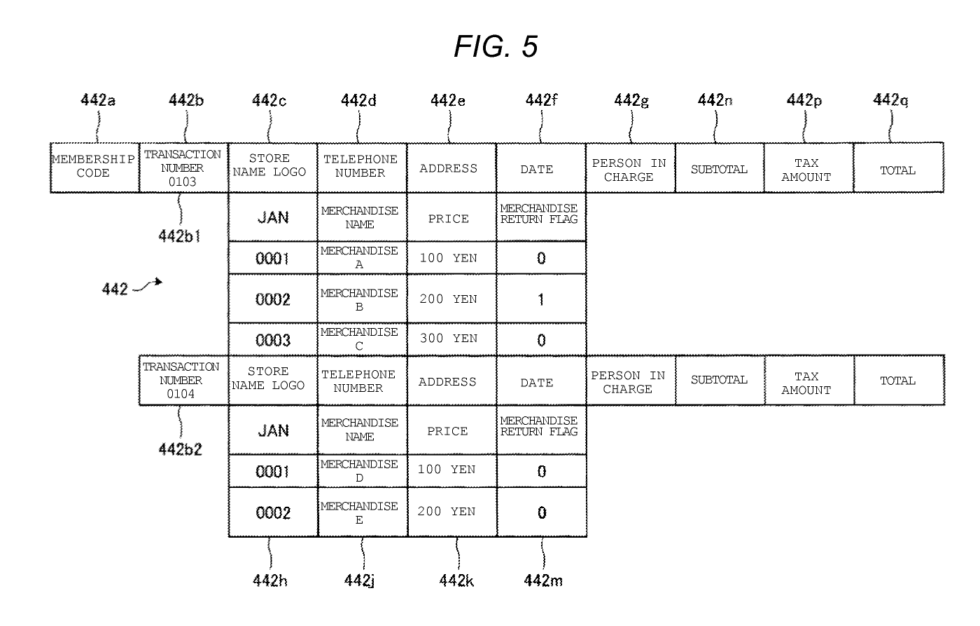

Next, the electronic receipt storage unit 442 will be described in detail. The electronic receipt storage unit 442 stores information related to the settled transaction with respect to each membership code. Specifically, in FIG. 5, the electronic receipt storage unit 442 has a membership code unit 442a, a transaction number unit 442b, a store name logo unit 442c, a telephone number unit 442d, an address unit 442e, a date unit 442f, a person-in-charge unit 442g, a code unit 442h, a merchandise name unit 442j, a price unit 442k, a merchandise return flag unit 442m, a subtotal unit 442n, a tax amount unit 442p, and a total price unit 442q. The disclosure describes a case where JAN code is stored in the code unit 442h. In countries other than Japan, a code which is used for the merchandise of the countries is stored.

The membership code unit 442a stores a membership code to specify the member. The transaction number unit 442b stores transaction number of a transaction by the member specified by the membership code. The transaction number is a number for specifying the transaction, and is referred to as a receipt number. In the example of FIG. 5, two transaction numbers, which are transaction number “0103” in a transaction number unit 442b1 and transaction number “0104” in a transaction number unit 442b2, are stored.

The store name logo unit 442c stores a logo of the store at which the transaction is carried out. The telephone number unit 442d stores a telephone number of the store. The address unit 442e stores an address of the store. The date unit 442f stores the date (settlement date) when the transaction is performed. The person-in-charge unit 442g stores a name of a person in charge who performs the transaction.

The JAN code unit 442h stores the JAN code to specify the merchandise purchased in the transaction. For example, a thirteen-digit JAN code has a two-digit country code, a five-digit manufacturer code, a five-digit merchandise code, and a one-digit check digit. The merchandise name unit 442j stores the merchandise name of the merchandise purchased in the transaction. The price unit 442k stores the price of the merchandise purchased in the transaction.

The merchandise return flag unit 442m stores the merchandise return flag which shows whether or not the merchandise is processed to be returned. The merchandise return flag “1” in the merchandise return flag unit 442m shows that the stored merchandise is processed to be returned (identification information). The merchandise return flag “0” in the merchandise return flag unit 442m shows that the stored merchandise is not processed to be returned. In the example of FIG. 5, since the merchandise return flag in the merchandise return flag unit 442m is “0”, a merchandise A, a merchandise C, a merchandise D, and a merchandise E are not processed to be returned. Meanwhile, since the merchandise return flag of the merchandise return flag unit 442m is “1”, the merchandise B is processed to be returned at the POS terminal 1.

The subtotal unit 442n stores the subtotal which is an aggregated price of the merchandise purchased in the transaction. The tax amount unit 442p stores a sales tax with respect to the subtotal. In the example of FIG. 5, the tax is included in the price of the merchandise. The total price unit 442q stores the total price, which is calculated based on the subtotal and the tax. In the example of FIG. 5, since a tax-included method is employed, the subtotal and the total price are the same.

In addition, in the example of FIG. 5, one membership code is described. However, the electronic receipt storage unit 442 stores a plurality of membership codes, and stores one or a plurality of transactions in association with each membership code.

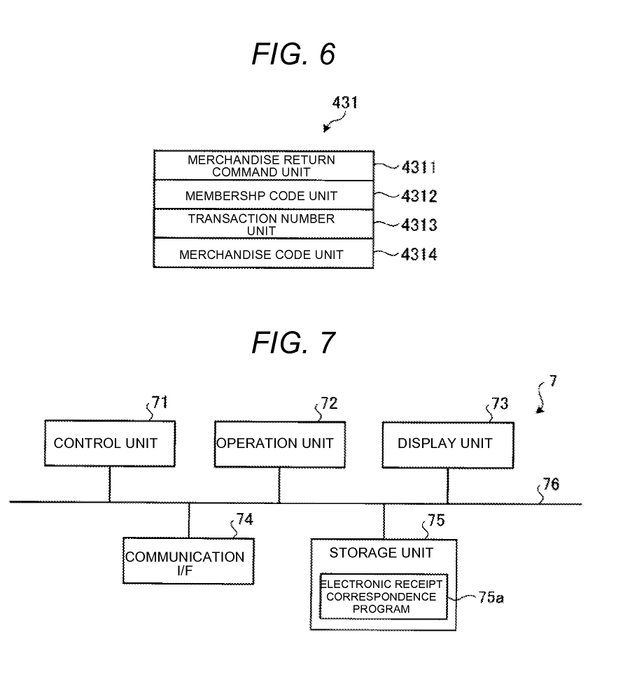

FIG. 6 is a memory map of the merchandise return data unit 431, which stores the merchandise return data in the RAM 43. The merchandise return data unit 431 has a merchandise return command unit 4311, a membership code unit 4312, a transaction number unit 4313, and a merchandise code unit 4314.

The merchandise return command unit 4311 stores the merchandise return command (returning merchandise processing information), which shows that the merchandise return processing is performed at the POS terminal 1. The membership code unit 4312 stores the membership code to specify the member who performs the merchandise return processing. The transaction number unit 4313 stores the transaction number to specify the transaction with respect to which the merchandise return processing is carried out. The merchandise code unit 4314 stores the merchandise code to specify the merchandise with respect to which the merchandise return processing is carried out. In addition, although not illustrated in the drawing, the company code is also stored.

Next, a configuration of the mobile terminal 7 will be described using a block diagram in FIG. 7. As illustrated in FIG. 7, the mobile terminal 7 has a control unit 71, which performs various arithmetic operations and generally controls each unit of the mobile terminal 7. The control unit 71 is a computer, which is configured to have a CPU, a ROM, which stores various programs or data, a RAM, which temporarily stores various programs or various kinds of rewritable data, and a RTC unit which measures the current date and time.

An operation unit 72 is connected to a display unit 73 via a bus 76. The operation unit 72 has various operation keys so that the customer (member) performs an operation input, and a pointing device. The display unit 73 is a liquid crystal display or the like, and displays various kinds of information, such as the electronic receipt. In addition, the display unit 73 may be a touch panel. In this case, the touch panel functions also as the operation unit 72.

In addition, the control unit 71 may be connected to a communication I/F 74 via the bus 76, and may be connected to the network N5 via the communication I/F 74. In addition, the control unit 71 may be connected to the in-store network N1 via the communication I/F 74.

In addition, the control unit 71 is connected to a storage unit 75 via the bus 76. The storage unit 75 stores an electronic receipt correspondence program 75a for receiving and displaying the electronic receipt from the electronic receipt management server 4, as well as the web browser for displaying various kinds of information (content), which is available on the web.

Next, a control processing of each component of the system according to the embodiment will be described.

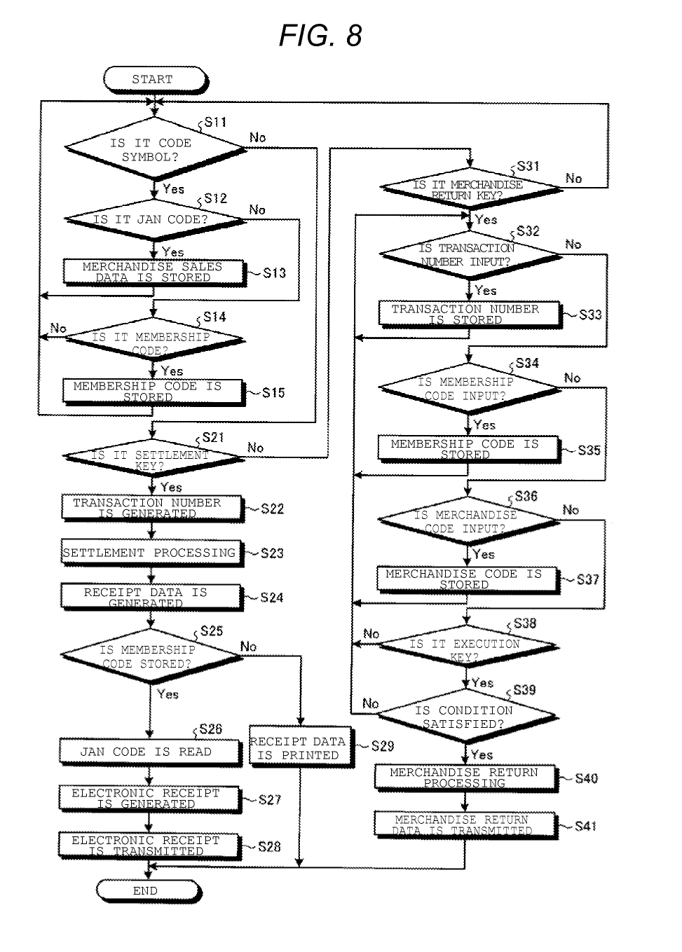

First, a flow of an electronic receipt generation processing and an electronic receipt data transmission processing, which are performed as a control unit 100 of the POS terminal 1 is operated according to the control program 141, will be described with reference to a flow chart illustrated in FIG. 8.

As illustrated in FIG. 8, the control unit 100 of the POS terminal 1 determines whether or not a code symbol is read by the code reading unit 21 (Step S11). When it is determined that the code symbol is read (YES at Step S11), the control unit 100 determines whether or not the read code symbol is a merchandise code (Step S12). The merchandise code includes a code representing the country, a code representing the merchandise, or the like, and the control unit 100 determines whether or not the code symbol is the merchandise code from the codes (Step S12).

When it is determined that the read code symbol is the merchandise code (YES at Step S12), based on the merchandise code included in the read code symbol, the control unit 100 reads out the merchandise information from the merchandise master 142 and controls the data storage unit 143 to store the merchandise information (Step S13). When the merchandise information corresponding to the merchandise code does not exist in the merchandise master 142, the control unit 100 obtains the merchandise information of the merchandise from the merchandise master (not illustrated) stored in the store server 2. In addition, at Step S13, the control unit 100 may obtain the merchandise information from the merchandise master of the store server 2 from the beginning. Then, the control unit 100 goes back to Step S11 and stands by.

In addition, when it is determined that the read code symbol is not the merchandise code (NO at Step S12), then, the control unit 100 determines whether or not the read code symbol is a membership code (Step S14). When it is determined that the read code symbol is the membership code (YES at Step S14), the control unit 100 controls the data storage unit 143 to store the membership code (Step S15). Then, the control unit 100 goes back to Step S11. In addition, when it is determined that the read code symbol is not the membership code (NO at Step S14), the control unit 100 goes back to Step S11.

Meanwhile, at Step S11, when it is determined that the code symbol is not read (NO at Step S11), the control unit 100 determines whether or not the settlement key 171 of the operation unit 17 is operated (Step S21). When it is determined that the settlement key 171 is operated (YES at Step S21), the control unit 100 generates the transaction number, recognizing that the transaction was carried out (Step S22). The control unit 100 performs the settlement processing, based on the generated transaction number and the total price of the transaction and the like (Step S23).

Next, the control unit 100 generates the receipt data related to the transaction, based on the information of the transaction which is processed to be settled (Step S24). The receipt data is the merchandise information, such as the merchandise name of the purchased merchandise and the price, and the purchasing information, such as the total amount of money, and the amount of change. The receipt data does not include the JAN code.

Next, the control unit 100 determines whether or not the membership code is stored in the data storage unit 143 (Step S25). When it is determined that the membership code is not stored (NO at Step S25), the control unit 100 controls the printing unit 20 to print on the roll-shaped receipt paper sheet the receipt, based on the generated receipt data which does not include the JAN code (Step S29). Then, the control unit 100 completes the processing.

In addition, when it is determined that the membership code is stored (YES at Step S25), the control unit 100 reads out the JAN code of the merchandise from the merchandise master 142, based on the merchandise information included in the generated receipt data (Step S26). The control unit 100 adds the JAN code to the receipt data generated at Step S24, and generates the electronic receipt (Step S27). The electronic receipt in the embodiment is data which includes information (442a to 442q) exemplified in FIG. 5, such as the membership code, the transaction number, or the JAN code, in addition to the entity code and the store code. Then, the control unit 100 transmits the generated electronic receipt to the electronic receipt server 3 which is specified by the entity code (Step S28). Then, the control unit 100 completes the processing.

In addition, at Step S21, when it is determined that the settlement key 171 is not operated (NO at Step S21), the control unit 100 determines whether or not the merchandise return key 173 is operated (Step S31). When it is determined that the merchandise return key 173 is operated (YES at Step S31), the control unit 100 determines whether or not the transaction number is input through the operation unit 17 or the code reading unit 21 (Step S32). When it is determined that the transaction number is input (YES at Step 32), the control unit 100 controls the data storage unit 143 to store the input transaction number (Step S33). Then, the control unit 100 goes back to Step S32.

Meanwhile, when it is determined that the transaction number is not input (NO at Step 32), then, the control unit 100 determines whether or not the membership code is input through the code reading unit 21 (Step S34). When it is determined that the membership code is input (YES at Step S34), the control unit 100 controls the data storage unit 143 to store the input membership code (Step S35). Then, the control unit 100 goes back to Step S32.

Meanwhile, when it is determined that the membership code is not input (NO at Step S34), then, the control unit 100 determines whether or not the merchandise code is input through the code reading unit 21 (Step S36). When it is determined that the merchandise code is input (YES at Step S36), the control unit 100 controls the data storage unit 143 to store the input merchandise code (Step S37). Then, the control unit 100 goes back to Step S32.

Meanwhile, when it is determined that the merchandise code is not input (NO at Step S36), the control unit 100 determines whether or not the execution key 172 is operated (Step S38). The execution key 172 is operated when the merchandise return processing is performed.

When it is determined that the execution key 172 is operated (YES at Step S38), the control unit 100 determines whether or not a condition to perform the merchandise return processing is satisfied (Step S39). When at least one of the transaction number and the membership code, and the merchandise code of the returned merchandise, is stored in the data storage unit 143, the control unit 100 determines that the condition to perform the merchandise return processing is satisfied.

When it is determined that the condition to perform the merchandise return processing is satisfied (YES at Step S39), the control unit 100 performs the merchandise return processing, based on at least one of the transaction number and the membership code, and the merchandise code, which are stored in the data storage unit 143 (Step S40). The merchandise return processing is a processing to remove the turnover data of the returned merchandise from the turnover data stored in the POS terminal 1 or in the store server 2, and to update a memory.

Then, the control unit 100 transmits at least one of the transaction number and the membership code, the merchandise code, the merchandise return command which shows that the merchandise return processing is performed, and the entity code to the electronic receipt server 3 which is specified by the entity code (Step S41). The merchandise return command is modification requesting data.

In addition, when it is determined that the execution key 172 is not operated (NO at Step S38), and when it is determined that the condition to perform the return processing is not satisfied (NO at Step S39), the control unit 100 goes back to Step S32. In addition, when it is determined that the merchandise return key 173 is not operated (NO at Step S31), the control unit 100 goes back to Step S11.

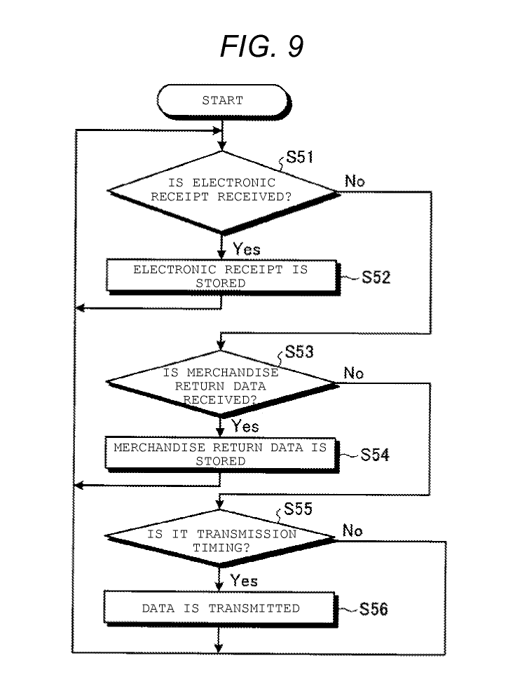

Next, a flow of the electronic receipt management processing which is performed as the control unit 31 of the electronic receipt server 3 is operated according to the control program 33b, will be described with reference to a flow chart illustrated in FIG. 9.

The control unit 31 of the electronic receipt server 3 determines whether or not the electronic receipt data transmitted from the POS terminal 1 is received via the communication I/F 32 (Step S51). When it is determined that the electronic receipt data is received (YES at Step S51), the control unit 31 stores the electronic receipt data as the electronic receipt for an entity in the electronic receipt storage unit 33a of the storage unit 33 (Step S52). The electronic receipt storage unit 33a is a storage unit which has data areas for each store code. In other words, the received electronic receipt is kept in the area for a corresponding store code. Then, the control unit 31 goes back to Step S51.

In addition, when it is determined that the electronic receipt is not received via the communication I/F 32 (NO at Step S51), then the control unit 31 determines whether or not the merchandise return data including the merchandise return command is received from the POS terminal 1 (Step S53). When it is determined that the merchandise return data is received (YES at Step S53), the control unit 31 stores the received merchandise return data (at least one of the transaction number and the membership code, the merchandise code of the returned merchandise, and the merchandise return command) in the electronic receipt storage unit 33a of the storage unit 33 (Step S54).

When it is determined that the merchandise return command is not received from the POS terminal 1 (NO at Step S53), the control unit 31 determines whether or not it is the timing for transmitting the merchandise return command to the electronic receipt management server 4 (Step S55). The control unit 31 transmits the electronic receipt or the merchandise return data which are stored and managed in the electronic receipt storage unit 33a, to the electronic receipt management server 4 at a predetermined timing. When it is determined that it is the timing for transmitting the merchandise return command to the electronic receipt management server 4 (YES at Step S55), the control unit 31 transmits the electronic receipt or the merchandise return data which are stored and managed in the electronic receipt storage unit 33a, to the electronic receipt management server 4 (Step S56). Here, the transmitted electronic receipt is the data which includes information (442a to 442q) exemplified in FIG. 5, such as the membership code, the transaction number, or the JAN code, in addition to the entity code. In addition, the entity code is added and transmitted to the merchandise return data. In addition, when it is determined that it is not the timing for transmitting the merchandise return command to the electronic receipt management server 4 (NO at Step S55), the control unit 31 goes back to Step S51.

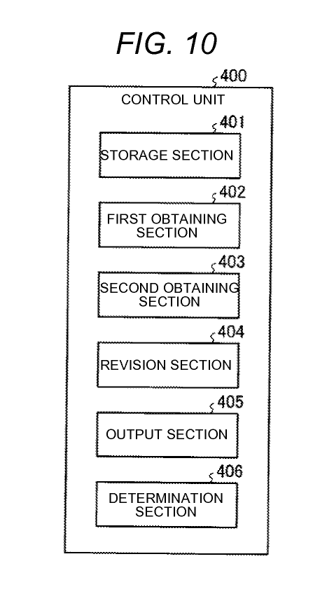

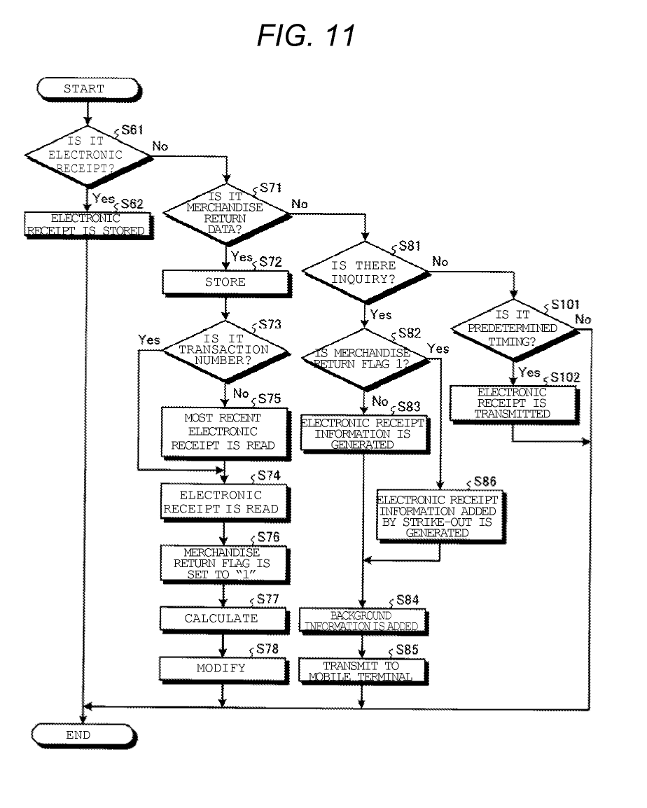

Next, a flow of the electronic receipt management processing which is performed as the control unit 400 of the electronic receipt management server 4 is operated according to a control program 441, will be described with reference to a functional block diagram in FIG. 10 and flow charts illustrated in FIG. 11.

As illustrated in FIG. 10, when the control program 441 is executed by the electronic receipt management server 4, a module including the following is generated: a storage section 401 which is the storage unit, a first obtaining section 402, which is the first obtaining unit, a second obtaining section 403, which is the second obtaining unit, a revision section 404, which is the revision unit, an output section 405, which is the output unit, and a determination section 406, which is the determination unit. Specifically, the storage section 401, the first obtaining section 402, the second obtaining section 403, the revision section 404, the output section 405, and the determination section 406 are generated, as the CPU 41 of the control unit 400 reads out the control program 441 from the storage unit 44 and executes it.

The storage section 401 has a function of storing the electronic receipt having the amount of money transacted corresponding to the reception destination specification information.

The first obtaining section 402 has a function of obtaining the modification request data of the electronic receipt from an external apparatus (i.e., POS terminal 1).

The second obtaining section 403 has a function of obtaining the inquiry request data together with the reception destination specification information.

The modification section 404 has a function of modifying the amount of money transacted with respect to the electronic receipt in the storage section 401 when the first obtaining section 402 obtains the modification request data.

The output section 405 has a function of outputting the electronic receipt including the modified amount of money when the electronic receipt of the reception destination specification information obtained by the second obtaining section 403 is modified by the modification section 404.

The determination section 406 has a function of determining whether the modification request data includes the transaction number or the reception destination specification information.

In FIG. 11, the control unit 400 of the electronic receipt management server 4 determines whether or not the electronic receipt generated by the POS terminal 1 is received from the electronic receipt server 3 (Step S61). When it is determined that the electronic receipt is received (YES at Step S61), the control unit 400 (storage section 401) inquires about the entity code which is included in the received electronic receipt, and stores the electronic receipt in the area for the entity code of the electronic receipt storage unit 442. In this case, the received electronic receipt is stored in the electronic receipt storage unit 442 in association with the membership code (Step S62). Then, the control unit 400 completes the processing.

When it is determined that the electronic receipt is not received from the electronic receipt server 3 (NO at Step S61), the control unit 400 (first obtaining section 402) determines whether or not the merchandise return data including the merchandise return command transmitted from the POS terminal 1 is received from the electronic receipt server 3 (Step S71). When it is determined that the merchandise return data is received (YES at Step S71), the control unit 400 stores the received merchandise return data in the merchandise return data unit 431 (Step S72). Specifically, the control unit 400 stores the merchandise return command in the merchandise return command unit 4311. In addition, the control unit 400 controls the membership code unit 4312 to store the merchandise return data when the membership code is included in the merchandise return data. In addition, the control unit 400 stores the merchandise return data in the transaction number unit 4313 when the transaction number is included in the merchandise return data. In addition, the control unit 400 stores the merchandise code of the returned merchandise in the merchandise code unit 4314.

Next, the control unit 400 (determination section 406) determines whether or not the transaction number is stored in the transaction number unit 4313 of the merchandise return data unit 431, or whether or not the membership code is stored in the membership code unit 4312, that is, whether or not the transaction number is included in the received merchandise return data, or whether or not the membership code is included (Step S73). When it is determined that the transaction number is included (YES at Step S73), the control unit 400 reads out the electronic receipt of the corresponding transaction number from the electronic receipt storage unit 442 (Step S74). Regarding the read electronic receipt, the control unit 400 sets the merchandise return flag of the merchandise return flag unit 442m to be “1”, corresponding to the merchandise code stored in the merchandise code unit 4314 (Step S76).

Then, regarding the read electronic receipt, the control unit 400 deducts the price of the merchandise processed to be returned from the subtotal in the subtotal unit 442n and the total price in the total price unit 442q, computes new subtotal and total price, and computes new tax amount from the tax amount of the tax amount unit 442p based on the price of the merchandise processed to be returned. (Step S77). The control unit 400 (revision section 404) stores the newly computed subtotal, tax amount, and total price in the subtotal unit 442n, the tax amount unit 442p, and the total price unit 442q, and updates the electronic receipt (Step S78). According to this, it is possible to provide the revised electronic receipt to the customer.

When it is determined that the transaction number is not included in the received merchandise return data and the membership code is included (NO at Step S73), the control unit 400 reads out an electronic receipt that includes the merchandise code of the returned merchandise stored in the merchandise code unit 4314 and that has the most recent date (settlement date), among electronic receipts associated with the corresponding membership code, based on the membership code stored in the membership code unit 4312 of the area corresponding to the received entity code of the electronic receipt storage unit 442 (Step S75). Then, processing of Steps S76 to S78 is performed with respect to the read-out electronic receipt.

Accordingly, when the customer returns the merchandise, even when the transaction number is not available, it is possible to modify the electronic receipt based on the member code and the merchandise code. It is possible to provide the modified electronic receipt to the customer.

In addition, at Step S71, when it is determined that the merchandise return data is not received from the electronic receipt server 3 (NO at Step S71), the control unit 400 (second obtaining section 403) determines whether or not there is an inquiry about the electronic receipt from the mobile terminal 7 (Step S81). The mobile terminal 7 transmits an inquiry based on the membership code and the date. The inquiry is the inquiry requesting data.

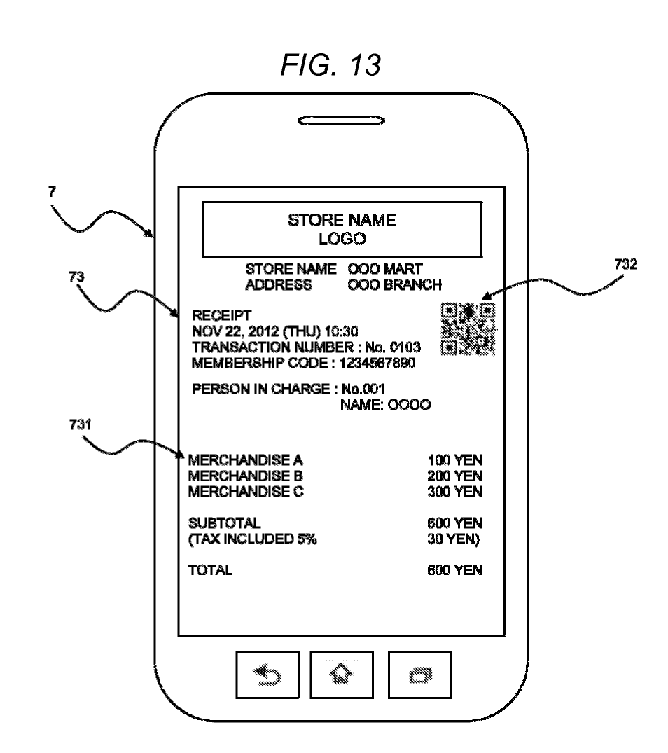

When it is determined that there is an inquiry (YES at Step S81), the control unit 400 determines whether or not the merchandise return flag “1” is included in the merchandise return flag unit 442m of the electronic receipt on the date when there is the inquiry (Step S82). When it is determined that the merchandise return flag “1” is not included (NO at Step S82), the control unit 400 reads out the necessary information from the electronic receipt of the corresponding transaction number from the electronic receipt storage unit 442, and generates an electronic receipt that is displayed on the display unit 73 of the mobile terminal 7 (Step S83) (see FIG. 13). In FIG. 13, a list of purchased items 731 is included in the electronic receipt displayed on the display unit 73 of the mobile terminal 7. In addition, a code (e.g., a QR code) 732 is included in the electronic receipt, the code 732 can be used when information about the electronic receipt is obtained by a POS terminal 1.

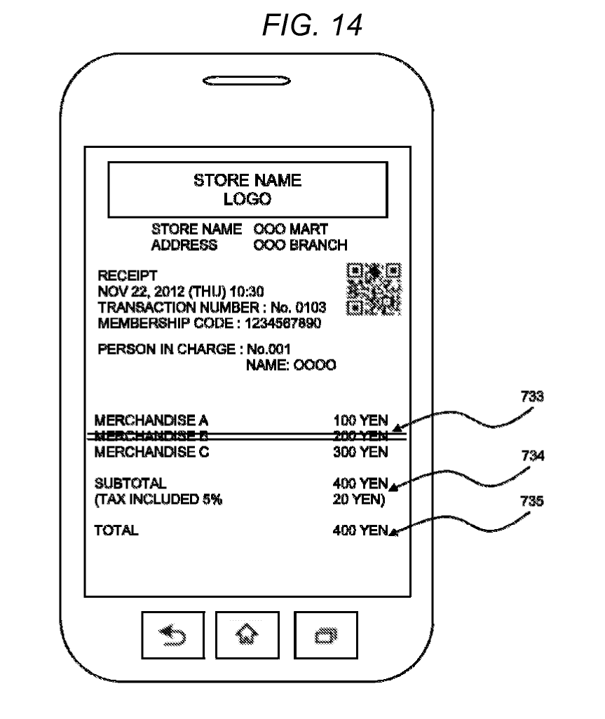

In addition, at Step S82, when it is determined that the merchandise return flag “1” is included (YES at Step S82), the control unit 400 adds strike-out information which displays the struck-through mark (deletion mark) 733 (see FIG. 14) with respect to the merchandise information of the merchandise of which the merchandise return flag is “1”, and generates the electronic receipt (Step S86). As shown in FIG. 14, the electronic receipt indicates that merchandise B is returned by the customer, using the struck-through mark 733. Further, the amount of subtotal 734 and total price of the transaction 735 are modified in accordance with the return of the merchandise B.

The control unit 400 reads out the background information, which is additional information, from the background storage unit 443, and adds the background information to the electronic receipt (Step S84). Then, the control unit 400 (output section 405) transmits the electronic receipt via the communication I/F 49 to the mobile terminal 7 (Step S85). The transmitted electronic receipt may not be all of the information which is stored in the electronic receipt storage unit 442. For example, only the merchandise name, the price, the subtotal, the amount of tax, and the total price are transmitted.

In addition, the background information added to the electronic receipt may be modified when necessary. For example, at the timing when the mobile terminal 7 displays the electronic receipt, the music used for promoting the sales may be played.

In addition, the watermark character as the background information, the pattern, the content, or the like may be added by combining the same.

When it is determined that there is no inquiry about the electronic receipt from the mobile terminal 7 (NO at Step S81), the control unit 400 determines whether or not it is the predetermined timing (Step S101). The electronic receipt management server 4 transmits the collected electronic receipt to the manufacturer server 8 periodically. Each manufacturer can analyze a turnover tendency of the merchandise, based on the received electronic receipt. The predetermined timing is the preset predetermined timing when the electronic receipt management server 4 transmits the collected electronic receipt to the manufacturer server 8.

When it is determined that it is the predetermined timing (YES at Step S101), the control unit 400 transmits the electronic receipt stored in the electronic receipt storage unit 442 to a corresponding manufacturer, with respect to each manufacturer (Step S102).

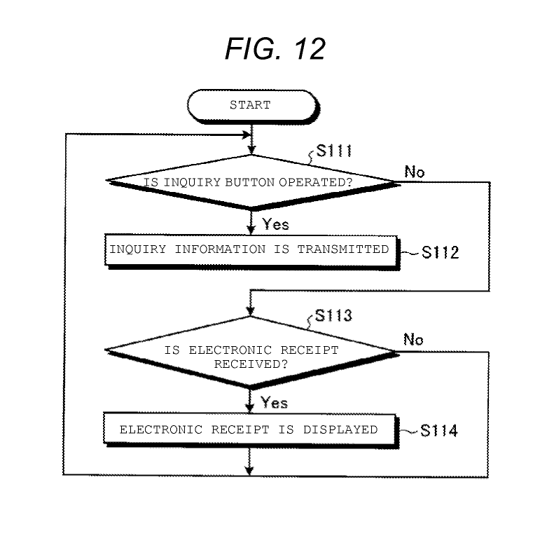

Next, the control processing of the mobile terminal 7 will be described using a flow chart in FIG. 12. The control unit 71 determines whether or not an inquiry button (not illustrated) for receiving the electronic receipt is operated (Step S111). When it is determined that the inquiry button is operated (YES at Step S111), the control unit 71 transmits the inquiry information for receiving the electronic receipt to the electronic receipt management server 4 (Step S112). Then, the control unit 71 goes back to Step S111.

In addition, when it is determined that the inquiry button is not operated (NO at Step S111), the control unit 71 determines whether or not the electronic receipt is received according to the processing of Step S85 from the electronic receipt management server 4 (Step S113). When it is determined that the electronic receipt is received, the control unit 71 displays the received electronic receipt in the display unit 73 (Step S114). Then, the control unit 71 goes back to Step S111.

The mobile terminal 7 which receives the electronic receipt displays the electronic receipt in the display unit 73 as the electronic receipt correspondence program 75a works.

When it is determined that the electronic receipt is not received (NO at Step S113), the control unit 71 goes back to Step S111 and stands by.

In the embodiment, when the electronic receipt is generated from the receipt data, the electronic receipt is generated with the JAN code and transmitted. For this reason, when the electronic receipt is transmitted to the manufacturer server 8, since the electronic receipt to which the JAN code is added is transmitted, the manufacturer P4 may specify the merchandise based on the transmitted electronic receipt.

An embodiment is described as above, but the embodiment is disclosed as an example, and the range of the exemplary embodiment is not limited. The embodiment may be other various embodiments, and it is possible to add various omissions, changes, modifications, and combinations without departing from the scope of the exemplary embodiment. The embodiment and the modification thereof are included in the range or the scope of the exemplary embodiment, and are included in the range equivalent to that of the exemplary embodiment mentioned in a range of claims.

For example, in the above-described embodiment, the membership code or the like is input through the code reading unit 21. However, the embodiment is not limited thereto, and the membership code or the like may be input by using another method. Specifically, when the POS terminal 1 and the mobile terminal 7 both have a short-range radio communication unit, such as a near field communication (NFC) or a Bluetooth (registered trademark), the membership code or the like may be transmitted and received by the short-range radio communication. In this case, the mobile terminal 7 maintains the membership code or the like in the storage unit 75 or in an IC tag (not illustrated) or the like.

In addition, in the above-described embodiment, the POS terminal 1 acquires the membership code or the like from the mobile terminal 7. However, the embodiment is not limited thereto, and the membership code or the like may be acquired from a medium (membership card) which may maintain the membership code, such as an IC card or a magnetic card. In addition, when the IC card is used, the POS terminal 1 has a reading and writing unit, such as an IC card reader or writer. In addition, when the magnetic card is used, the POS terminal 1 has a card reader or a card writer of the magnetic card.

In addition, in the above-described embodiment, the electronic receipt server 3 is located in the head office P2. However, the embodiment is not limited thereto, and the electronic receipt server 3 for the corresponding store may be located in the store P1. In this case, the POS terminal 1 transmits the electronic receipt to the electronic receipt server 3 which is connected to the in-store network N1 in the own store, and the electronic receipt server 3 transmits the electronic receipt data to the electronic receipt management server 4 via the in-store network N1 and the network N2.

In addition, in the above-described embodiment, the electronic receipt generated at the POS terminal 1 is transmitted to the electronic receipt management server 4 via the electronic receipt server 3. However, the embodiment is not limited thereto, and by accessing the electronic receipt management server 4 via the network N3 from the POS terminal 1, the electronic receipt may be directly transmitted to the electronic receipt management server 4.

In addition, in the above-described embodiment, the electronic receipt management server 4 stores the merchandise return flag, but the merchandise return flag may be managed in any apparatus if the apparatus manages the electronic receipt.

In addition, in the above-described embodiment, the mobile terminal 7 receives the electronic receipt from the electronic receipt management server 4. However, the embodiment is not limited thereto, and the electronic receipt may be directly received from the POS terminal 1. In this case, the POS terminal 1 outputs the generated electronic receipt to the mobile terminal 7, which is connected via the in-store network N1 or the short-range radio communication unit (not illustrated).

In addition, in the embodiment, the POS terminal 1 stores a merchandise data file. However, the embodiment is not limited thereto, and the store server 2 may store the merchandise data file to be able to be referred from the POS terminal 1.

In addition, in the embodiment, the JAN code is used as the merchandise specification information for the description. However, the embodiment is not limited thereto, and a code or information which specifies the merchandise may be used.

In addition, the program which is executed at the merchandise sales data processing apparatus according to the embodiment is recorded in a recording medium which is readable by the computer, such as a CD-ROM, a flexible disk (FD), a CD-R, or a digital versatile disk (DVD), as a file in a format that may be installed or a format that may be executed.

In addition, the program which is executed at the merchandise sales data processing apparatus according to the embodiment may be stored on the computer connected to the network, such as the Internet, and may be downloaded through the network. In addition, the program which is executed at the merchandise sales data processing apparatus according to the embodiment may be provided through the network, such as the Internet, and distributed.

In addition, the program which is executed at the merchandise sales data processing apparatus according to the embodiment may be provided by previously incorporating in the ROM 42 or the like.

In addition, the POS terminal is described, but the embodiment may be employed in a self checkout system.

Furthermore, in the embodiment, a part of the merchandise purchased by the customer is returned, but it is possible to employ the embodiment even when all of the merchandises are returned. In this case, the condition of S39 is that the transaction number is stored in the data storage unit 143.

The electronic receipt management server 4 stores the transaction number in the transaction number unit 4313. When only the transaction number is stored in the merchandise return data unit 431, the merchandise return flag of all of the returned merchandises of the corresponding transaction number is “1”. Furthermore, the flag of the subtotal, the amount of tax, and the total price is “0”. In this manner, it is possible to handle the case.

In addition, the returning of the merchandise after calculating the adjustment is described, but it is possible to employ the embodiment even when the merchandise is exchanged after calculating the adjustment. By considering the merchandise return flag as an exchanging flag, it is possible to handle the case by newly adding and storing the exchanged merchandise.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A handheld computing device comprising:
a control unit including a processor and memory;
a communication interface controlled by the control unit to communicate with an electronic receipt server that stores electronic receipt data; and
a display unit controlled by the control unit to display a user interface that includes
a transaction identifying symbol,
a listing of one or more items indicated as having been purchased based on data of a previously issued electronic receipt stored in the electronic receipt server and transmitted to the handheld computing device in response to an update request to the data, and
a deletion mark overlaid on or in proximity to one of the items to indicate that the item has been returned.

2. The handheld computing device according to claim 1, wherein
the update request is received by the electronic receipt server.

3. The handheld computing device according to claim 1, wherein
the update request includes a transaction code corresponding to the transaction identifying symbol.

4. The handheld computing device according to claim 1, wherein
the update request includes identification information of the item on or in proximity to which the deletion mark is overlaid.

5. The handheld computing device according to claim 1, wherein
the update request includes identification information of a customer who returns the item.

6. An electronic receipt server, comprising:
a storage unit that stores an electronic receipt generated based on a transaction; and
a communication interface configured to receive an update request to the electronic receipt from a handheld computing device; and
a control unit configured to control the communication interface to transmit to the handheld computing device, in response to the receiving of the update request, data for a user interface that is displayed on the handheld computing device, the user interface including
a transaction identifying symbol,
a listing of one or more items indicated as having been purchased based on data of the electronic receipt stored in the storage unit, and
a deletion mark overlaid on or in proximity to one of the items to indicate that the item has been returned.

7. The electronic receipt server according to claim 6, wherein
the electronic receipt includes a transaction code of the transaction,
the update request includes a transaction code of the transaction, and
the control unit is configured to transmit the data for the user interface when the transaction code of the electronic receipt corresponds to the transaction code of the update request.

8. The electronic receipt server according to claim 6, wherein
the electronic receipt includes an item code of an item purchased through the transaction,
the update request includes an item code of an item for which an update is requested, and
the control unit is configured to transmit the data for the user interface when the item code of the electronic receipt corresponds to the item code of the update request.

9. The electronic receipt server according to claim 6, wherein
the electronic receipt includes a customer code of a customer who purchased an item through the transaction,
the update request includes a customer code of a customer who returns an item, and
the control unit is configured to transmit the data for the user interface when the customer code of the electronic receipt corresponds to the customer code of the update request.

10. The electronic receipt server according to claim 6, wherein
the electronic receipt includes information about a total price of the transaction including a price of the returned item, and
the data for the user interface includes information about a total price of the transaction without the price of the returned item.

11. The electronic receipt server according to claim 6, wherein
a control unit configured is further configured to update the electronic receipt stored in the storage unit based on the update request.

12. The electronic receipt server according to claim 11, wherein
the electronic receipt includes information about a total price of the transaction, and
the control unit updates the total price of the electronic receipt stored in the storage unit.

13. The electronic receipt server according to claim 11, wherein
the control unit is further configured to control the storage unit to store information indicating that the electronic receipt has been updated, in association with the updated electronic receipt.

14. A method for processing an electronic receipt, comprising:
storing an electronic receipt generated based on a transaction;
receiving an update request to the electronic receipt from a handheld computing device; and
responsive to the update request, transmitting to the handheld computing device data for a user interface that is displayed on the handheld computing device, the user interface including
a transaction identifying symbol,
a listing of one or more items indicated as having been purchased based on data of the stored electronic receipt, and
a deletion mark overlaid on or in proximity to one of the items to indicate that the item has been returned.

15. The method according to claim 14, wherein
the electronic receipt includes a transaction code of the transaction,
the update request includes a transaction code of the transaction, and
the data for the user interface is transmitted when the transaction code of the electronic receipt corresponds to the transaction code of the update request.

16. The method according to claim 14, wherein
the electronic receipt includes an item code of an item purchased through the transaction,
the update request includes an item code of an item for which an update is requested, and
the data for the user interface is transmitted when the item code of the electronic receipt corresponds to the item code of the update request.

17. The method according to claim 14, wherein
the electronic receipt includes a customer code of a customer who purchased an item through the transaction,
the update request includes a customer code of a customer who returns an item, and
the data for the user interface is transmitted when the customer code of the electronic receipt corresponds to the customer code of the update request.

18. The method according to claim 14, wherein
the stored electronic receipt includes information about a total price of the transaction including a price of the returned item, and
the data for the user interface includes information about a total price of the transaction without the price of the returned item.

19. The method according to claim 14, further comprising:
updating the electronic receipt stored in the storage unit based on the update request.

20. The method according to claim 19, further comprising:
storing information indicating that the electronic receipt has been updated, in association with the updated electronic receipt.
